(19) United States
(12) Patent Application Publication
(10) Pub. No.: US 2013/0088868 A1
(43) Pub. Date: Apr. 11, 2013

(54) LAMP WITH MULTIPLE COMBINED LIGHT REFLECTORS, LAMP CONNECTOR, AND PROXIMITY SENSOR FOR THE LAMP

(71) Applicants: Christopher SLOWINSKI, Great Neck, NY (US); Wieslaw BOBER, Astoria, NY (US); Lewis LIU, Shenzhen (CN); Krzysztof KAZANA, Krakow (PL); Kamil SIENKIEL, Ostrowiec Swietokrzyski (PL)

(72) Inventors: Christopher SLOWINSKI, Great Neck, NY (US); Wieslaw BOBER, Astoria, NY (US); Lewis LIU, Shenzhen (CN); Krzysztof KAZANA, Krakow (PL); Kamil SIENKIEL, Ostrowiec Swietokrzyski (PL)

(21) Appl. No.: 13/565,197

(22) Filed: Aug. 2, 2012

(30) Foreign Application Priority Data
Aug. 2, 2011 (PL) P.395849

(51) Int. Cl. F21V 7/00

(52) U.S. Cl. CPC F21V 7/00
USPC 362/247

(57) ABSTRACT

Lighting systems and lighting assemblies are disclosed, including a lamp with several light sources positioned to produce a smoother more blended lighting effect. Three or more light sources may be included, and each source can be positioned in its own light well. The light wells can be conical in form but may have a side of a cone missing to connect it to adjacent light wells, including to both adjacent light wells. A proximity sensor may be included to turn on or off the lamp or to dim the lamp when a user's presence is detected.

### CROSS-REFERENCE TO RELATED APPLICATIONS

The present application claims priority of Polish Patent Application No. P.395849 filed Aug. 2, 2011, the entire contents of which are hereby incorporated in full by reference.

### FIELD OF THE INVENTION

The present invention relates to furniture lighting and lamps with multiple light sources and proximity sensors, including lighting that may be installed after the furniture has been installed, and to lamps with multiple LED light sources positioned in light wells.

### BACKGROUND OF THE INVENTION

LEDs have many advantages, including that they can be driven by a low voltage system, however it is sometimes desirable to provide multiple LEDs as part of the same lamp for increased brightness. However, sometimes when installing more than one LED in lamp, the light that is emitted is not uniform or is not blended properly or the light sources are not mounted in an efficient and effective way.

Furniture lighting sets often are equipped with LED lamps or other types of lighting that may be embedded in holes in the furniture or installed on the surface of the furniture, and the lights are driven by electronic drivers linked powered by an AC/DC adapter.

Sometimes additional lighting may be necessary or desirable for furniture and it is advantageous to be able to install the lighting without first having to remove the furniture or without major alteration of the furniture. Also, it is advantageous to install lighting without having to install new power lines in or on a piece of furniture or a panel of a desk or furniture of the like.

In many settings, it is sometimes undesirable to require a user to touch a switch with his hands for turning on or off the switch or for controlling the dimming switch. In a kitchen, people's hands are wet or covered with food, and the switch may over time become dirty or unhygienic. Also in a hospital setting a number of other types of applications, including doctor offices, clinics, restrooms, and the like, it may be advantageous to provide a switch that does not require physical contact by a user's hands to control the opening of a door or drawer or cabinet or the like, or to turn on, turn off or to dim a light or a light system.

Other features and advantages of the present application will become apparent from the following description of the invention that refers to the accompanying drawings.

### SUMMARY OF THE INVENTION

According to another aspect of the invention, more than one LED light source is positioned in the same lamp to provide an increased quantity of illumination while providing a blending of the light from the light source as positioned inside. Further the lamp can avoid the creation of a circular beam of light and can create a more diffuse and smoother effect.

Also, the direction or tilt of the lamp is advantageously controlled. A lamp can include several light wells, for example three light wells, with the light source positioned inside each light well. The light wells can be adjacent to one another and can be divided by two partial walls between each light well, the partial walls forming part of a cone or a truncated cone that forms a light well but with a side of the cone or truncated cone omitted so as to adjoin the light wells. More than three or fewer than three wells and light sources may also be provided.

According to another aspect of the invention, a furniture lighting set is equipped with connectors which enable attachment of both wires of a power supply line and wires for lamp to the surface of a furniture; connectors comprising a cylinder casing equipped with the leading grooves on the outside, placed parallel to each other. Cutting members or cutting knives placed in the casing can be inserted into the leading grooves while being pressed by a resistance plate. The knives have two blades placed on two levels, and are parallel to each other, so that they can cut the insulation and thereby achieve a connection of the lighting system to the existing power supply line.

According to another aspect of the invention, a proximity sensor can detect a presence of a user's hand or the like so as to activate the lamp or to turn off or to dim the lamp, or to open a drawer of a cabinet or bureau or to open a door of a desk or a closet or a cabinet or the like, or to open a door or a window or to control the portion of a recline chair or the like. According to another aspect of the invention, an improved light device has multiple compartment reflectors that improves light focus and intensity.

Other features and advantages of the present invention will become apparent from the following description of the invention, which refers to the accompanying drawings.

### BRIEF DESCRIPTION OF THE DRAWINGS

FIG. 1 is a schematic diagram illustrating a lighting system, according to an aspect of the invention.

FIG. 2 illustrates an electric driver in perspective view, according to an aspect of the invention.

FIG. 3 illustrates a proximity switch in perspective view, according to an aspect of the invention.

FIG. 4 is a connector for the wires of a power supply in perspective view, according to an aspect of the invention.

FIG. 5 is a connector for the wires of a power supply in an exploded view, according to an aspect of the invention.

FIG. 6 is an illustration of a longitudinal section of a lamp with casing for an open installation, according to an aspect of the invention.

FIG. 7 is an illustration in a longitudinal section of a lamp with casing in an exploded view, according to an aspect of the invention.

FIG. 8 is a cross-section illustration of a touch button positioned behind the panel for detecting a presence of a user according to an aspect of the present invention.

FIG. 9 illustrates the same touch button with an object that is ignored, according to an aspect of the invention.

FIG. 10 illustrates a lighting control system with components of the system, according to an aspect of the invention.

FIG. 11 shows the component of the system as illustrated in FIG. 11, but without the motion sensor, according to an aspect of the invention.

FIG. 12 illustrates the component of the system as illustrated in FIG. 10, and also shows a motion sensor.

FIGS. 13-16 show the lamp in various mounted positions, including a recessed mounting sunk into the furniture.

FIG. 17 is an exploded view of a lamp, including three light wells for light sources, according to an aspect of the present invention.

FIG. 18 illustrates the lamp with the light emitting portion tilted according to a preference of the user, according to an aspect of the present invention.

FIG. 19 illustrates the system as shown in claim 10, but with a mechanical switch added to an adjusted motion sensor, according to an aspect of the present invention.

FIG. 20 illustrates components of the system as illustrated in FIG. 10, but also shows a light intensity sensor.

FIG. 21 illustrates components of the system and a television feedback loop, according to an aspect of the present invention.

FIG. 22 illustrates components of the system including a mini server attached to the system.

FIG. 23 illustrates components of the system, including a remote controller for activating the lamp, according to an aspect of the present invention.

FIG. 24 is a perspective view of the drawers of the cabinet activated by a sensor, according to an aspect of the present invention.

FIG. 25 is a perspective illustration of the drawers of the cabinet that do not open beyond a certain point depending on the detected presence of an obstacle in the way, according to an aspect of the present invention.

FIG. 26 illustrates a touch button mounted on to a tabletop or a furniture top surface, such as on top of the cabinet, a countertop, an appliance or the like, according to an aspect of the present invention.

FIG. 27 illustrates touch button underneath an exterior surface or plate furniture underneath a tabletop, a countertop, inside an appliance, or the like, according to an aspect of the present invention.

FIG. 28 shows that when a presence of a body appears within the sensitive area and then leaves the sensitive area within a critical area, sometimes designated as a filtering time, the touch button 35 will register as a significant event this entering and leaving of the body or object, and will interpret this event as a turning or turning off operation, according to an aspect of the present invention.

FIG. 29 illustrates that while touch button 35 will interpret the entry into the sensitive area and the leaving from the sensitive area of a body or object such as the user's finger, or hand or other type of triggering presence, touch button 35 will ignore an obstacle or element that is left within the sensitive area during the entire filtering time, according to an aspect of the present invention.

FIGS. 30 and 31 illustrate touch button 35 controlling the output to end-power units JB-V1 or JB-V2, according to an aspect of the present invention.

FIGS. 32 and 33 provide a decision algorithm for controlling the switch according to an aspect of the present invention.

FIGS. 34-43 are perspective views illustrating components of the system illustrated in FIGS. 19-23, according to an aspect of the present invention.

FIGS. 44-46 illustrate a lamp including reflectors with three different beaming angles for controlling the light from the lamps 122-124, according to an aspect of the present invention.

FIG. 47 illustrates three different lamp configurations providing, respectively a 30° light beam cone, a 70° light beam cone, and a 100° light beam cone, according to an aspect of the present invention.

FIG. 48 illustrates a recess mounting, in which the lamp is mounted inside a recess or aperture in the furniture or panel of a furniture, according to an aspect of the present invention.

FIG. 49 illustrates a surface mounting, in which the mounting equipment is invisible from an outside to the casual observer, according to an aspect of the present invention.

FIG. 50 illustrates another version of the surface mounting called an ear type surface mounting, in which a pair of mounting rings are visible on either side of the lamp, according to an aspect of the present invention.

FIG. 51 illustrates a surface mounting with decorative ring around the lamp which is mounted using the ear type mounting rings, according to an aspect of the present invention.

FIG. 52-54 illustrate, respectively, a narrow beam of light, a medium width cone of light, and a broader cone of light, according to an aspect of the present invention.

FIG. 55 illustrates lamps emitting different light color ranges, according to an aspect of the present invention

FIG. 56 illustrates an adaptive threshold chart for the sensor, according to an aspect of the present invention.

FIG. 57 illustrates an in-window adaptive threshold chart for the sensor, according to an aspect of the present invention.

FIG. 58 is a schematic illustration of an electrical circuit for the sensor according to an aspect of the present invention.

### DETAILED DESCRIPTION OF EMBODIMENTS OF THE INVENTION

A double wired line of the power supply can be attached to the surface of the furniture with a connector 9, which is attached to the double wired line before installation. Electrical connection can then be made with the double wired line by cutting separately an insulator in each wire. An aim of an aspect of the present invention is to be able to attach additional connector after the power supply line has already been installed, without first dismantling the line, so as to be able to install additional sources of light. The furniture lighting may also include an electric driver with an AC/DC adapter that is connected to the double wired power supply line for the LED lamps. LED lamps are fixed to both wires and the wires are embedded in or behind the furniture.

According to an aspect of the present invention, the connector 9 can secure to a furniture both wires of the double wired line of the power supply as well as those connected to the lamp. The connector 9 has a cylinder casing 10 equipped with leading grooves 11 on the outside placed parallel to each other, and the chord is set near to the cross-section of the casing 10. The casing 10 is also equipped with cutting knives which enter the leading grooves simultaneously, for example using a screw. The cutting knives 12 have two blades 13 positioned on two levels and are perpendicular to each other. The blades of the knives 12 are shaped and oriented to cut only an insular cover of the wires and have the effect of achieving the electrical connection.

An insulating plate 16 is positioned between cutting knives and a resistance plate 14 is provided on top of the insulating plate 16. The housing or casing has holes for wires of a lamp, the holes at the surface of the casing 10 are positioned perpendicular to the leading grooves 11 for the wires of the power supply unit. The two sets of wires are placed perpendicular or transverse with respect to each other.

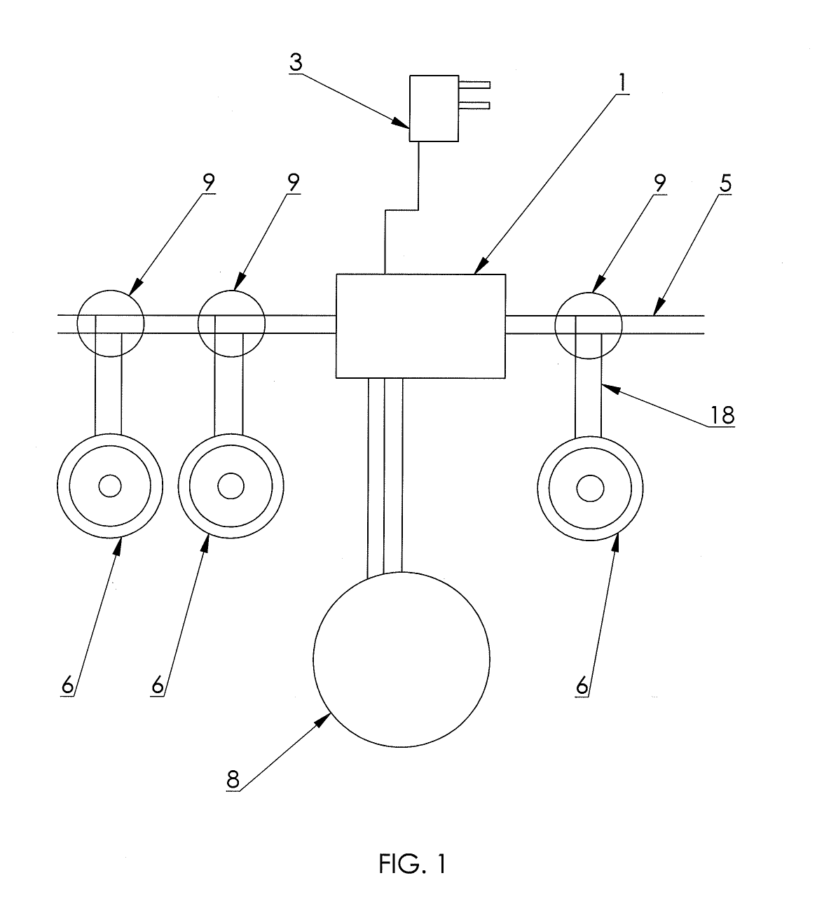

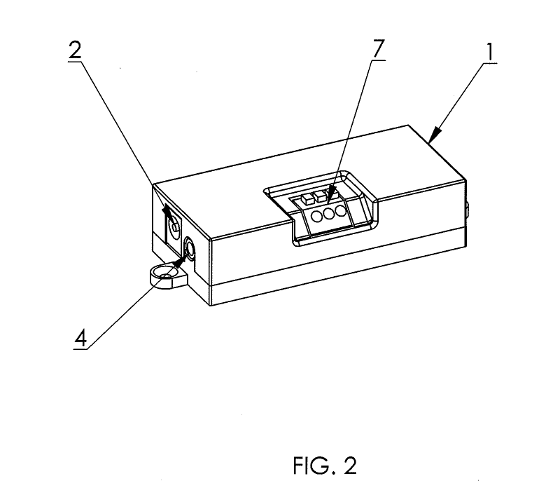

The lighting system illustrated in FIG. 1 is also equipped with an electrical driver 1 connected to a power source via a power supply unit 5. The electric driver unit 1 includes an outlet for the double wire power supply.

A furniture lighting set is equipped with an electrical driver 1 connected through power supply outlet 2 with an AC/DC adapter 3 and can also include at least one outlet for double wire power supply line 5 for lamp or light source 6. The lamp source may be LED lamps, incandescent bulbs, halogen lamps, fluorescent lighting, or other types of light sources.

Electrical device 1 is also equipped with a control interface 7 connected to the proximity lighting switch 8. Electric drives 1 can also include a dimmer switch to adjust the intensity of light, and can be controlled via a twilight sensor, a movement sensor or other types of sensors for controlling the light.

The wires of power supply 5 can be attached to the surface of the furniture, such as under a cabinet for under cabinet lighting, inside furniture, for example, for an in drawer or in closet application, or at an external surface of the furniture, using connectors 9.

Connector 9 has a cylinder casing 10 however other shapes are also contemplated such as rectangular, oval or other shapes. Leading grooves 11 on the outside of casing 10 accommodate wires of a power supply line 5, and leading grooves 11 are placed parallel to each other, whereas the chord is set toward cross-section of casing 10. Casing 10 includes cutting knives 12 which are positioned vertically and can be inserted into leading grooves 11.

Cutting knives 12 have two blades 13, which are positioned on two levels, levels 1 and 2, and the blades 13 are set perpendicular to each other. A resistance plate 14 with the aid of screw 15 can be used to press cutting knives 12 into the leading grooves 11. An insulating plate 16 is positioned between cutting knives 12 and resistance plate 14. Cutting knives 12 are shaped, configured and positioned to cut only an insulator cover of the wire of power supply line 5 and to have the effect of achieving electric connection. Thus, when the cutting knives 12 are pressed down, the two blades can cut the insulator cover of power supply line 5 and create an electrical connection with the unit.

Casing 10 has holes 17 for wires 18 of lamp 6, which can be positioned perpendicular on the surface of connector 9 to leading grooves 11 for wires of the power supply unit 5. Connector 9 can be attached to the surface of a furniture using screws or other types of fastening devices (not shown).

A proximity light switch can also be included for the driver 1 so as to turn on and off the light without direct touching of the switch. The switch can be installed in the panel of the furniture or beneath the panel. The intensity of the light emitted from the light source can also be adjusted using a twilight sensor and a dimmer switch or a movement sensor.

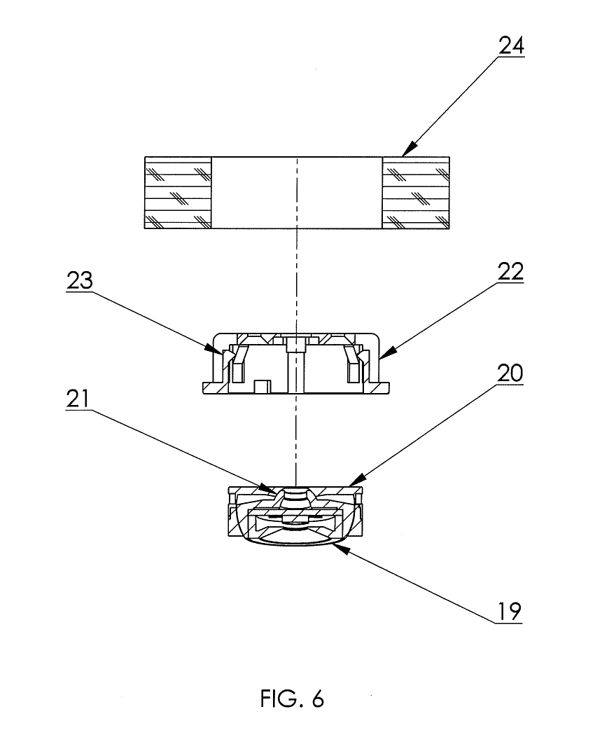

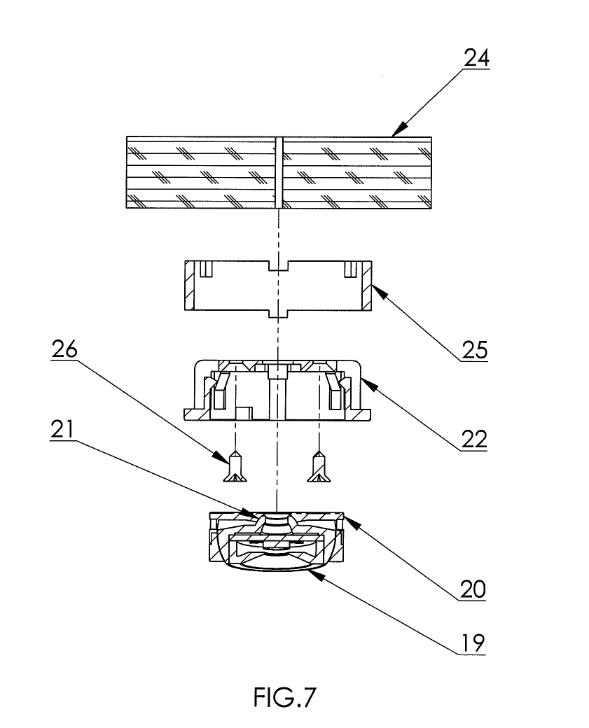

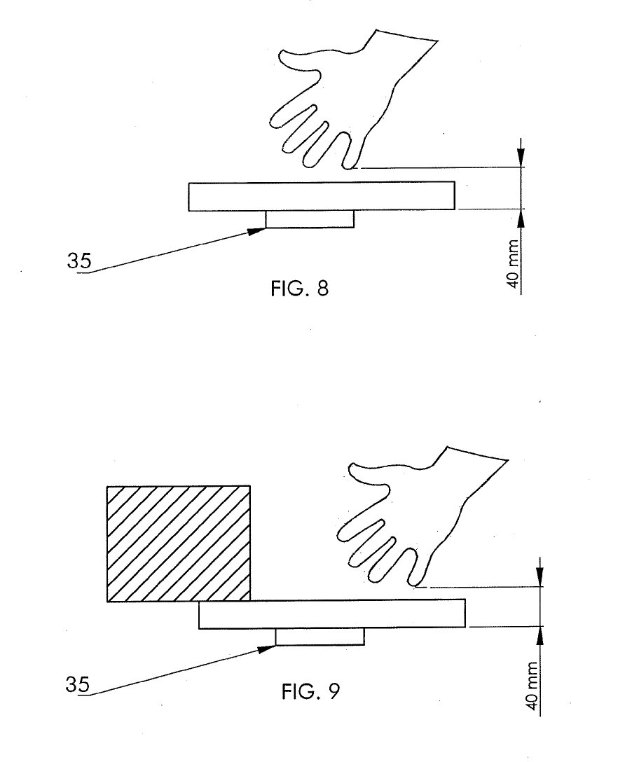

The lamp 6, illustrated in FIG. 6 can be equipped with a spherical joint so as to allow the bending of the source of light in all directions. An outlet 22 of the lamp has catches 23 outside and/or inside that are retractable, and the catches 23 can block movement of the outlet 22 at the panel surface. The lamp 6 can be attached with a snap fastener for more than one snap fasteners 23 in a special ring affixed to a panel of furniture 24 or inside one of the holes in the furniture.

An advantage or effect according to the invention is that the lamp can be freely installed after the installation of the furniture, and even after the installation of the electrical wire. Connectors that can hold simultaneously two sets of wires so as to allow the choosing freely of the position of a number of sources of light. The outside leading grooves 11 allow adding connectors after the set has been installed.

Lamp 6 can include head 19 positioned inside the housing or casing 20 and can move on a spherical joint 21 and can be located in a separate outlet 22. Outlet 22 can include catches 23 outside and inside, which can block an outlet, and a lamp at the set surface. Lamp 6 can be positioned in the holes in a furniture plate 24 or on the surface of plate 24.

The precise position of the lamp 6 in the hole in the surface of furniture plate 24 is at one of the sides of the hole. The precise position in the hole can be the inside of the side of ring 25, fixed to plate 2 with screws 26. During installation of light set connector 9, screws can be used to attach it to the surface of the furniture or other types of fastening devices including brackets, bolts or nails or the like can be used. Wires of power supply line 5 are inserted in connector 9 by pulling the wire through leading grooves 11. The wires 18 that supply power to the lamp 6 are inserted through hole 17. Using screw 15, cutting knives 12 can then be pressed to the insulator of both the power supply line 5 and the wires 18 that connect to the lamp 6. Because the blades 13 of cutting knives 12 are positioned at two levels perpendicular to each other, as discussed above, the insulator covers of both power supply line 5 and wire 18 can be cut simultaneously and an electric connection can be achieved with both at the same time. The joint placing of both power supply line 5 and wires 18 also allow tightening so as to achieve a more snug and secure fit.

Additional connectors 9 and additional lamps 6 can also be placed on power supply line 5. These power supply lines 5 can be positioned in leading grooves 11 and wires 18 leading to the additional lamp 6 can be positioned in hole 17. As with the first connector, using screw 15, the cutting knives 12 can be then inserted into leading grooves 11 of these additional connectors 9.

Lamp 6 can also be installed on the outside using hidden screws or then can be attached using a snap fastener system without the aid of screws. As discussed, lamp 6 can be positioned on a spherical joint 21 to allow tilting and positioning in a way that prevents direct eye contact of the rays of light emitted by the lamp 6.

According to another aspect of the invention the lighting system enables a variety of sensors for controlling a LED lamp or other types of light sources, as described above.

According to another aspect of the present invention, a proximity light switch can be installed or beneath the surface of furniture. The switch 35 can be positioned behind the panel of furniture, the door or drawer or the like without creating a problem for sensing the presence of the user in front of the furniture given a thickness of a panel of furniture of, for example, 20 mm. Switch 35 works when a hand approaches without touching, or with touching the surface of plate 2 or when the user's hand moves away from plate or panel 2. Alternatively, the switching on or off may be activated only when the hand is held for a set time near or on the plate. A more traditional switch may also be provided to allow direct contact and switching on and off of the light. The dimmer switch may be controlled so that depending on how long the hand is held near or at plate 2 the lighting gets more intense or the lighting gets dimmed or less intense. In addition, the system can memorize the intensity from the previous activation of the lamp 6 and can provide the same amount of illumination as it did most recently before it switched off.

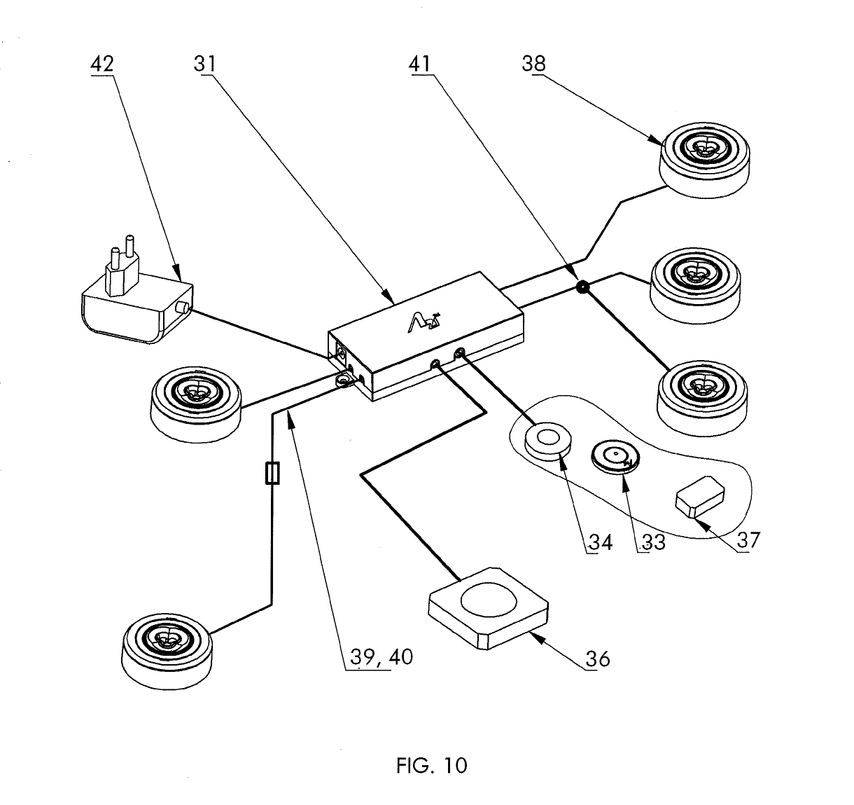

A junction box 31 illustrated in FIG. 10 has outputs for an LED lamp 38, or for more than one such LED lamp. Four outputs are shown however as would be readily understood, many or fewer such outputs may be provided for junction box 31, depending on the configuration and the requirement for the like. As discussed, while referring throughout to two LED lamps, it would be understood that any type of light source may be used in addition to or instead of the LED lamps. The junction box 31 illustrated in FIG. 10 also includes power supply unit 42, which can be a 12 volt DC with one amp, however it is understood that many other types of light sources may be used within the spirit of the invention, mechanical sensors, for example mechanical foil button with LED light 33, mechanical microswitch button 34, magnetic switch 37 or the like, and motion sensor 36B.

Another junction box 32 is shown for the touch button and is illustrated in FIG. 11. Junction box 32 includes outputs 8 for LED lamps, power supply unit 42, and touch button 35.

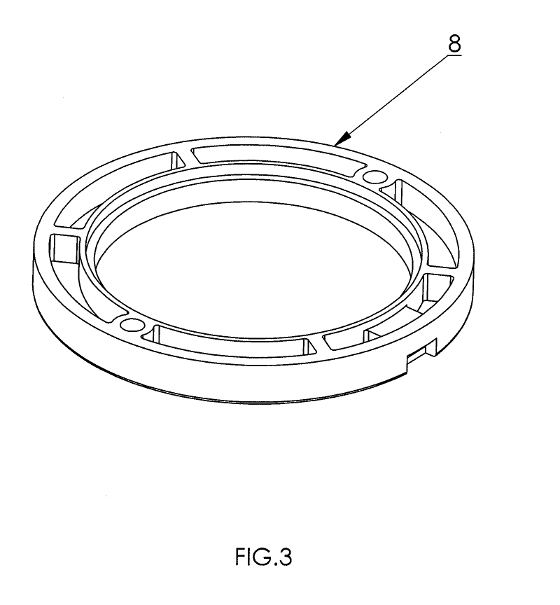

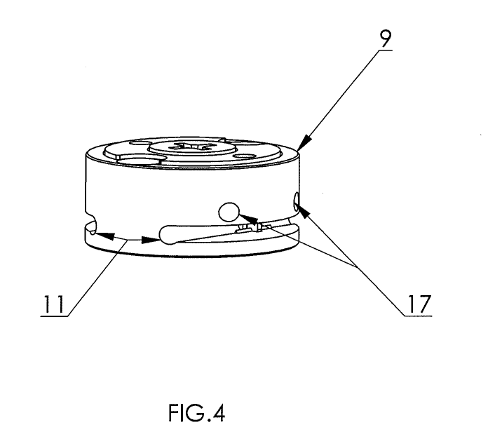

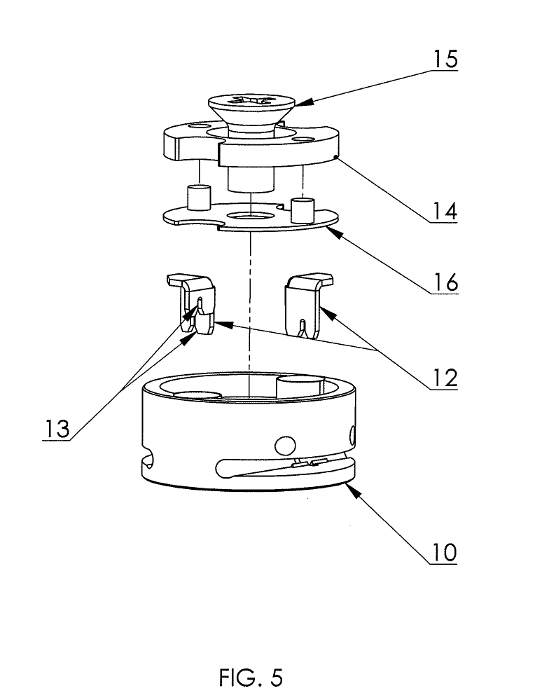

Extension cables, such as an extruded cable, which may be 50 cm in length, or more or less than this, an extruded cable with a longer length, for example 170 cm, or more or less than 170 cm, and splitter 41 are also illustrated in FIGS. 3 and 4. Typically, a set of ten LED lamps may be connected to junction box 1 or 2 however more or fewer than ten may also be provided. LED lamp cables, extension cables, and splitter have a jack joined that may be 2.5 mm mono. However, jack joints of smaller or larger dimensions may also be provided. The head of the LED lamp may be pivoted, for example up to 10°, in any direction.

Touch button 35 may include a sensor positioned to sense a proximity of user's hand or finger, or the like, and to turn on or to switch off the light according to the system illustrated in FIG. 11. The system may be installed, for example, under a work surface of a desk or underneath a panel of furniture as discussed above. For example, the touch button 35 may sense the presence of a user's hand, or the like up to 40 mm away. Moving a user's palm or finger or the like, or an object held by user, toward the touch button 35 or toward the place behind which the touch button is mounted can result in the switching on or turning off of the lamp. The touch button is sensitive through a desk surface, furniture panel, or through a distance unobstructed by furniture, for example, the thickness of the furniture or panel may be 40 mm, however the thickness may be more or less depending on the material and depending on the needs of the application. The user's hand or other limb may up to, for example 40 cm away from the touch button 35 for the touch button 35 to sense the user's presence. However, a greater or smaller distance may be set depending on the needs of the application and the type of panel or furniture behind which the touch button 35 is mounted.

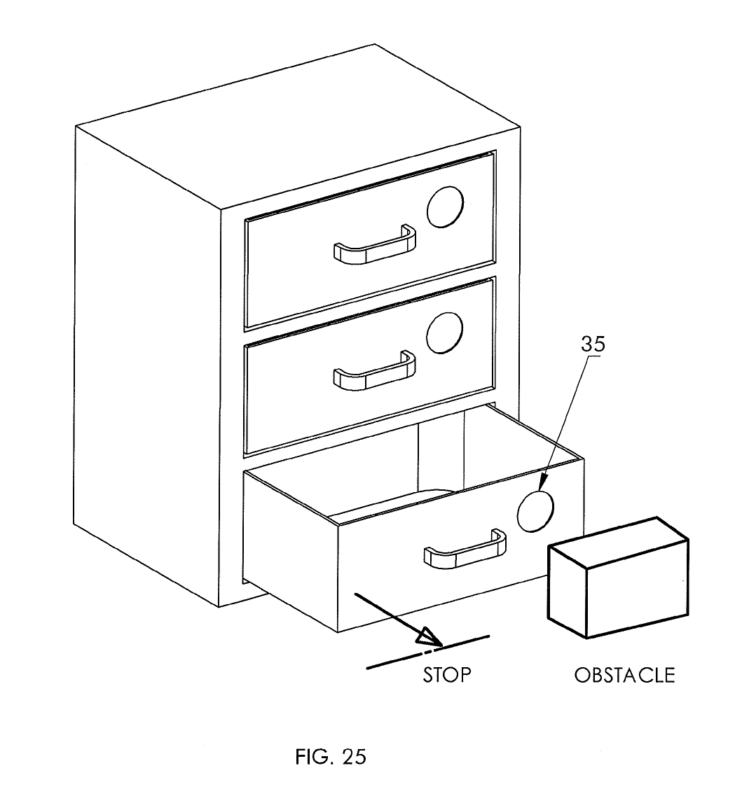

Touch button may be implemented using a capacitance module so as to sense a presence of a user's hand. Similarly, touch button 35 may be implemented using a wireless module, that uses, for example a disturbance detected in a RF wave to sense the user's presence. Expressed differently, the impedance to a signal between electrodes or the electrical field might be measured to sense the presence and/or movement of a user's hand adjacent the touch button. Touch button 35 may adapt to the presence of a stationary item or more than one such item, such as another piece of furniture or an item left on the furniture, and thus remove interference caused by the presence of the stationary item when using a wireless detection mode, as illustrated in FIG. 25. For example, element 52 left near touch button 35 can result in the sensor adapting for such an object so as to still react to the presence or non-presence of the user's hand or to the motion of the user. A determination of the change may be made based on detection of a one time instantaneous detection of the presence of the user, or more than one samplings may be used to determine a change. For example, a return signal from the radio frequency signal emitted by the detection module may be detected as changed a set number of times before a determination is made that the user's hand is present. Touch button 35 can send a signal to junction box 32 to notify of a change sensed. Junction box can include a microprocessor or a printed circuit board to make the determination as to whether the presence of a user's hand is detected and to control the light source in accordance with the determination made.

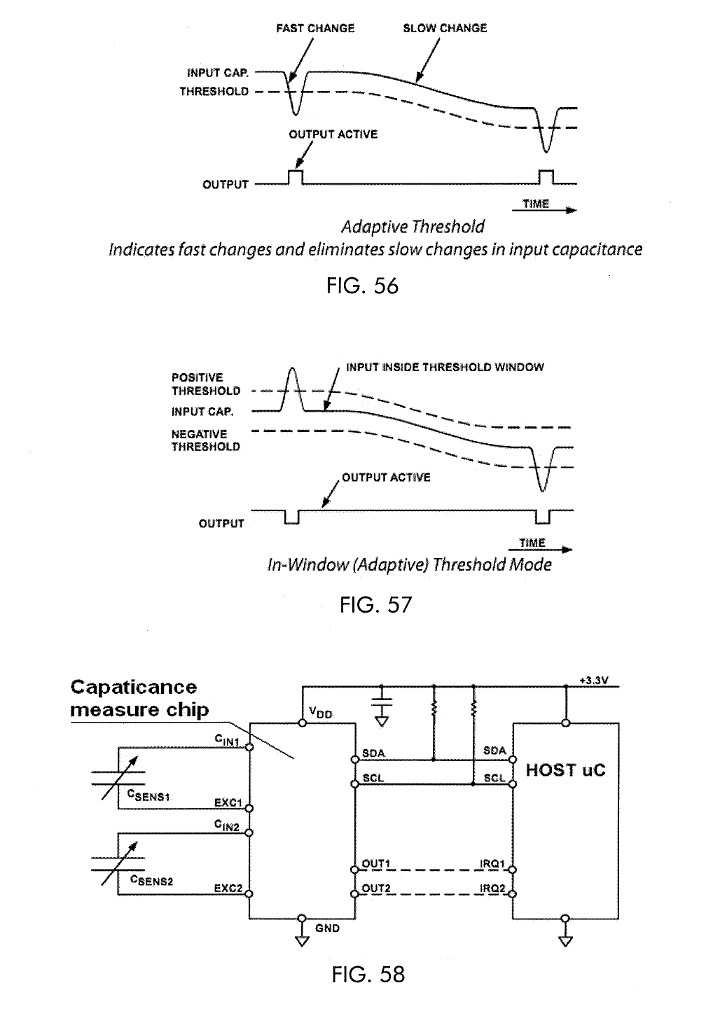

A circuit diagram for the capacitance measuring mode of the sensor is illustrated in FIGS. 56-58.

FIG. 56 illustrates an adaptive threshold mode of the sensor, which will react to a fast change in the sensed environment within the sensitive zone. In this adaptive mode, a threshold is determined within the sensitive zone of the sensor. Repeated sampling can be used to produce values that change slowly over time and thus the threshold can be determined. In the alternative, the capacitance detected may be averaged over a small time period relevant for the sampling rate of the sensor to arrive at the threshold level. In addition, the input capacitance can be determined based on repeated sampling, and a fast change is detected because the input capacitance is compared with the threshold value. The sensor will transmit an active output signal to signal the presence of a user's hand or other object only when the change is a fast change based on the comparison of the input capacitance with the threshold. Thus, slow changes in input capacitance can be eliminated as non-events. FIG. 56 also illustrates that the detection can be based on both a rapid decrease in the detected signal, responsive to a user entering the sensitive zone, and a rapid increase in the signal detected, responsive to the user leaving the sensitive zone. This in keeping with the idea discussed herein that the detector interprets a significant event and generates an output signal to control the lamp only when the user both enters and leaves the sensitive zone. However, alternatively, the system can respond even if the user is detected to enter the sensitive zone.

The threshold can thus be an adaptive threshold depending on the environment detected by the sensor. Rather than being static, the threshold will move and adapt in response to slow signal changes, that is the relative difference in the signal detected. This slow level change is then interpreted as the accepted or given threshold signal and is considered to be an event that will warrant an output signal from the detector to control the lamp. In general, a capacity value outside of the threshold that is set will trigger an output signal from the detector. The output signal will generate a positive pulse, or a high pulse from the detector so as to control the lamp.

FIG. 57 illustrates an in-window adapted threshold mode in which both the positive threshold and the negative threshold are calculated so that a capacitance window or envelope can be provided for the input capacitance signal detected at any given sampling time. The negative threshold represents the averaged capacitance sensed corresponding to a lower level, while the positive threshold represents an average capacitance sensed at the higher end of values. An output signal from the sensor indicating a change or presence of the user or other object within the sensitive field of the sensor will be transmitted only when the input capacitance is determined to be within the envelope marked by the positive threshold on the upper end and the negative threshold on the lower end of values. Thus, in principle, the positive threshold and negative threshold are for a positive capacity change and for negative capacity change, respectively. Together the positive threshold and negative threshold build an envelope or a threshold window. A capacity value detected that falls outside of the window can generate a negative pulse that is low.

FIG. 58 is a schematic illustration of an electrical wiring diagram for a capacitance measuring chip for the detection circuit of the sensor.

EXC1 provides power supply for sensor C_{SENS1}. Further, C_{IN1} is the incoming signal for the sensor entering the capacity measure chip. The same is true for the second sensor. VDD is the supply voltage for the chip. GND is ground. SDL stands for Serial Data Line. CTL stands for Serial Clock Line, that is for synchronizing the data transmission. SDA and CTL are signals for the FC data bus, that is the data bus used by the microcontroller, which is needed for data exchanges between microcontroller and capacity measure chip.

IRQ1/IRQ2 are signals for the FC data bus. They are interrupt channels, and are used by microcontroller to receive a signal edge from the capacity chip OUT1/OUT2 if the rising and falling edge is used that is parameterized by programmer for the application. If such an edge is detected by microcontroller, then the microcontroller will stop execution of the main routine and will commence execution of the dedicated program called the interrupt routine. Thus, there are two different interrupt routines, one for IRQ1 and one for IRQ2. Afterwards, the microcontroller returns to execution of the main routine. In this way, the edge on IRQ1 or IRQ2 forces microcontroller to act rapidly so as to achieve a rapid or fast reaction time.

Mechanical sensors, such as mechanical foil button 34 with LED light, and mechanical microswitch button 34 are illustrated in FIG. 10. Such mechanical sensors enable sequential changing of the intensity of the light to provide a dimming switch function. In a related manner, motion sensor 36a may be provided to detect a motion for triggering the turning on or off of the light and a darkness sensor or twilight sensor may be provided so as to turn on the light, for example when an ambient lighting condition is sensed as a dark or darker than a threshold lighting condition. Magnetic sensor 37 may also be provided so as to switch on the light when the door of a room or a door of a cabinet, or the like is detected.

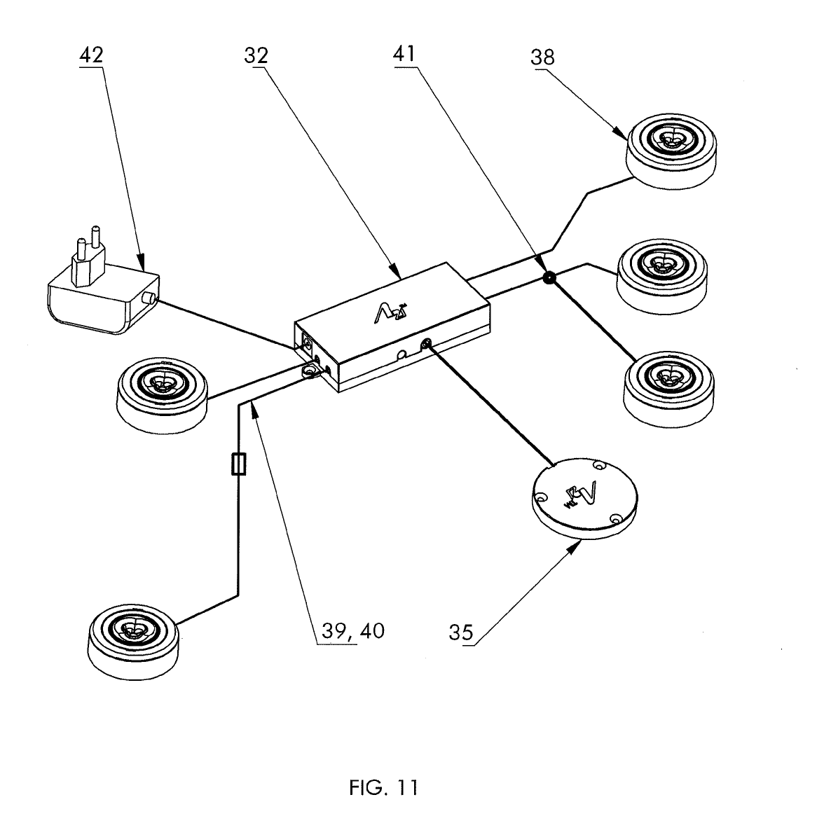

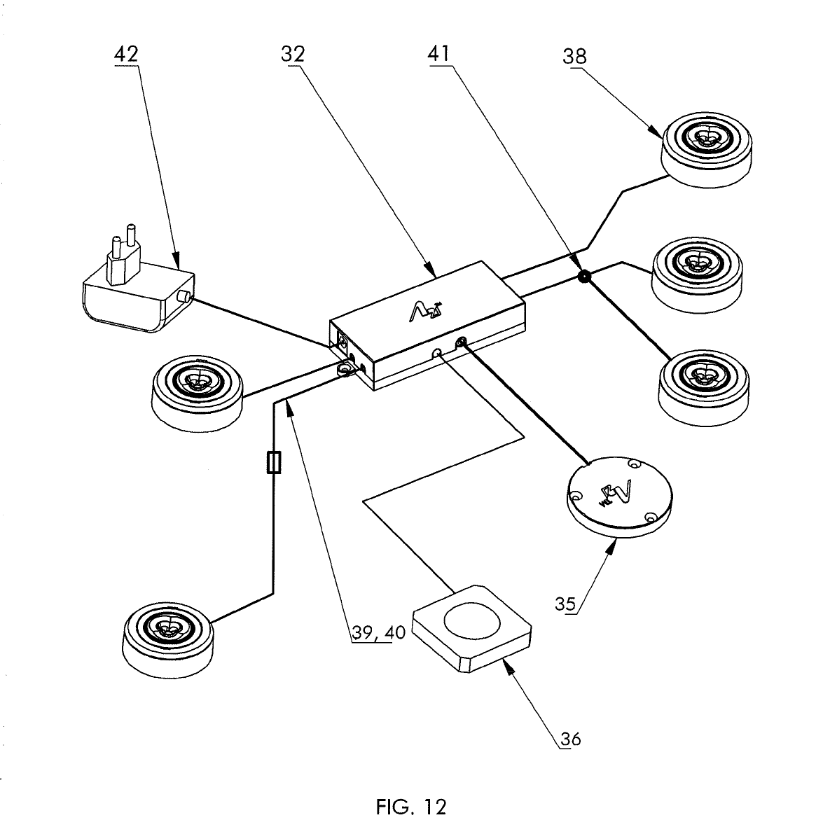

An example of a motion sensor according to the invention is shown in FIG. 12.

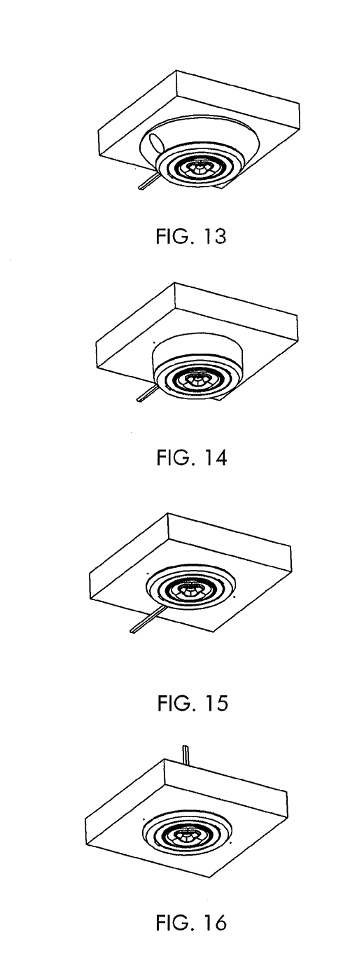

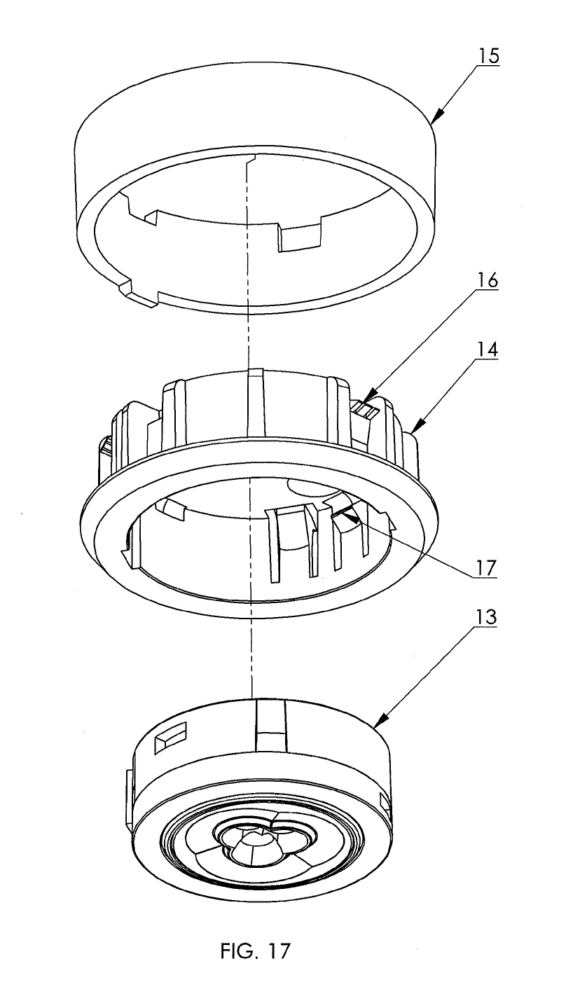

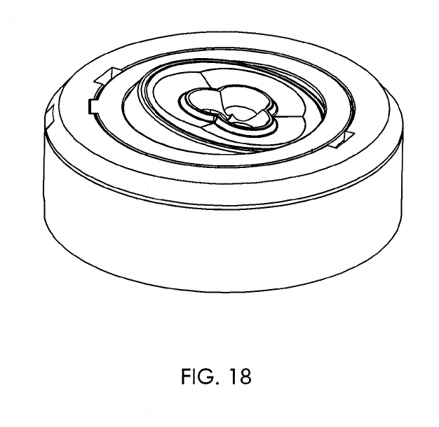

LED lamp 38 may be installed so as to be positioned outwardly of the housing, as illustrated, for example, in FIGS. 13 and 14. LED lamp 38 may be installed by means of mounting ring, such as external ring 45, for example using screws, as illustrated in FIG. 13 or using a mounting element, such as snap ring 44, which is mounted by screws (FIG. 14) and then by clicking by catch 47, illustrated in FIG. 17.

An internal installation, installation inside of cabinet or furniture or the like, can be accomplished using two elements, such as LED lamp head 13, and snap ring 14, and clicking ahead by catches 17 can result in forcing snap fastener 16 so as to block the lamp in a hole. A supply cable can be let outside by making a cut in the lamp.

Another mounting mode is, as shown in FIG. 16, similar to the above-mentioned mounting mode, but also using a cable let outside a mounting plate.

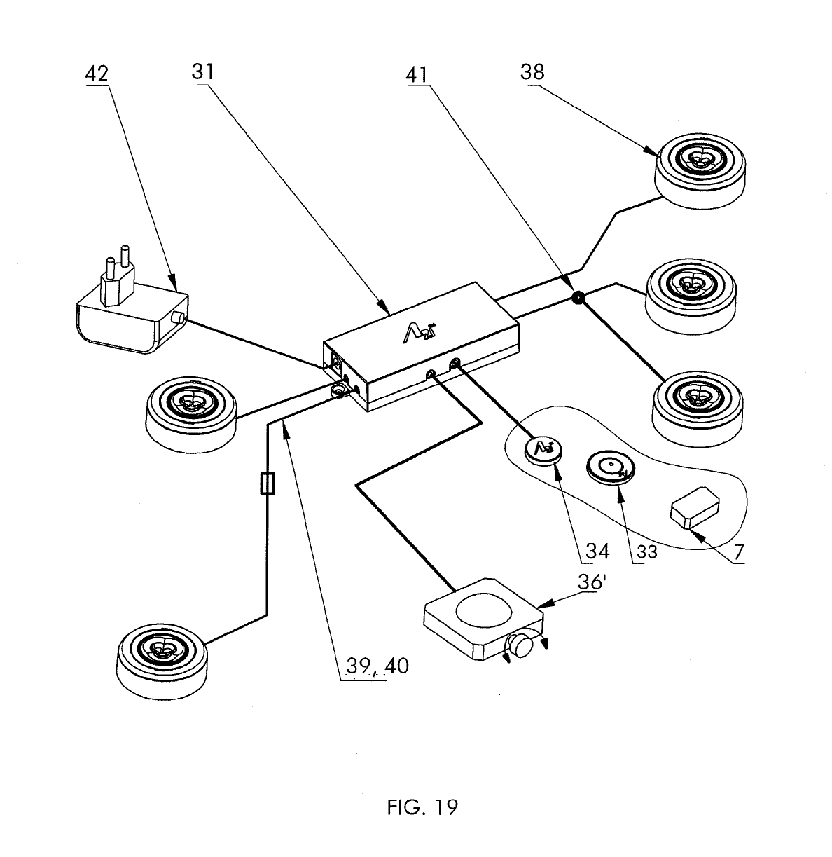

Additional elements may also be provided, such as motion sensor 36b for controlling the turning on and turning off of the light. This is illustrated in FIG. 19.

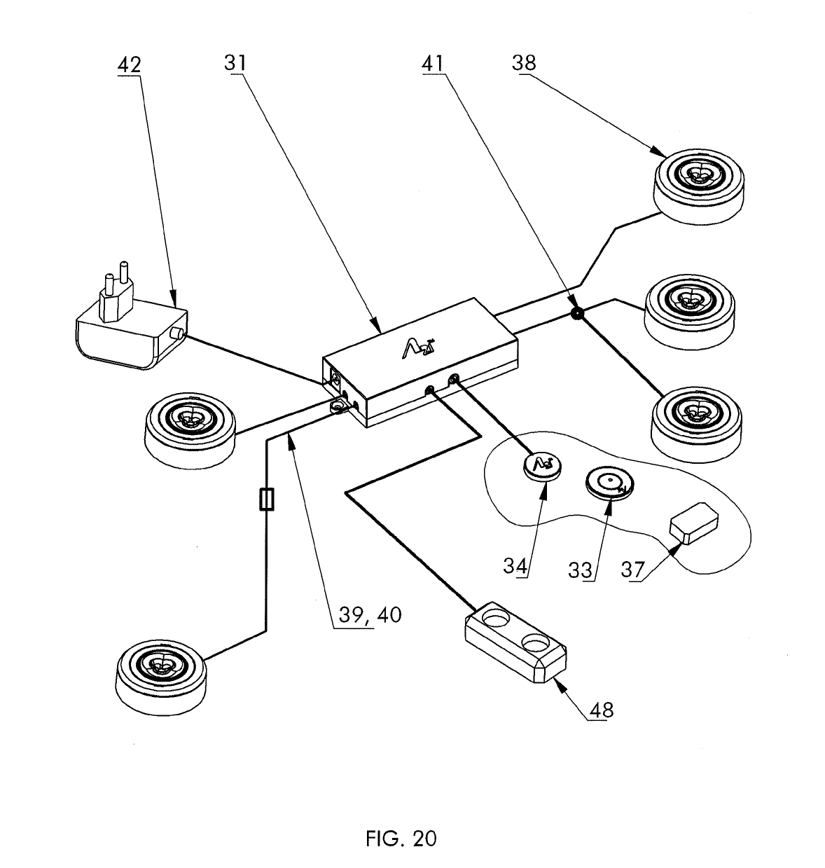

Light sensor 48 that detects a light intensity, as illustrated, for example in FIG. 20 may also be provided so as to measure illumination of an ambient light (natural and/or artificial light) for controlling the on/off switch or for dimming the light.

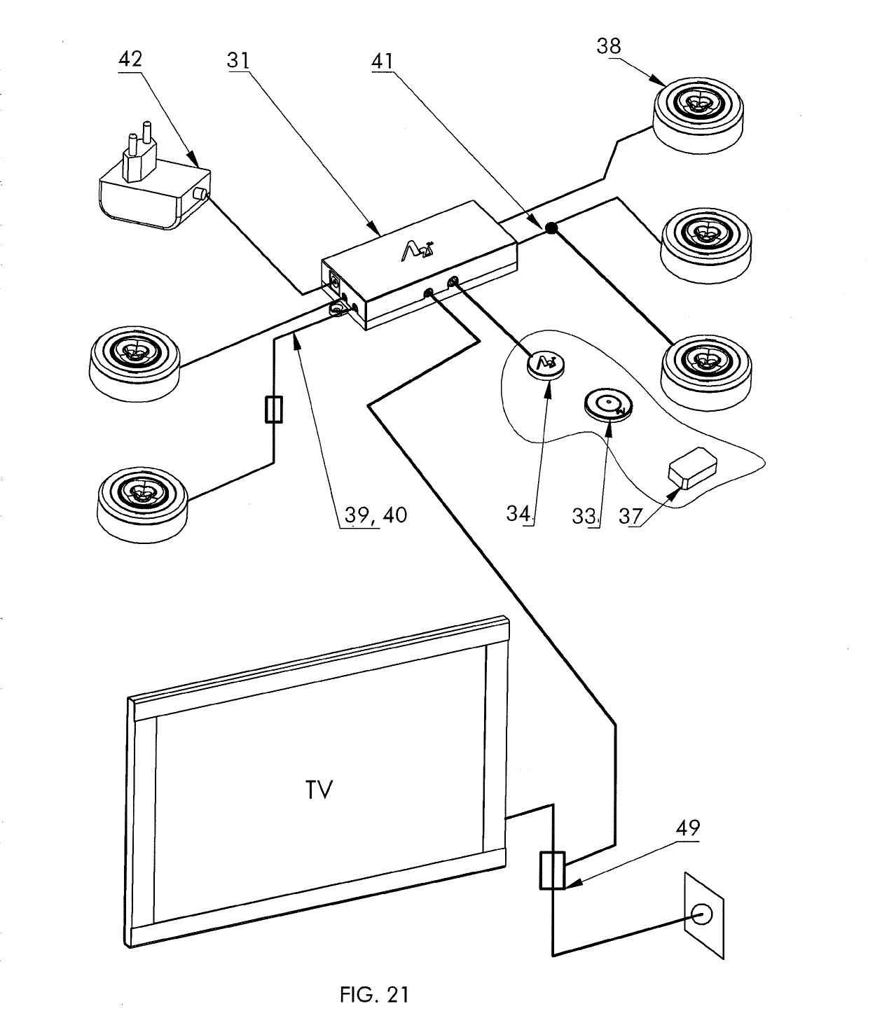

A current sensor can also be provided for measuring the current of a cable supply for a TV set. In this way current intensity sensor 49, illustrated in FIG. 21, can work as a feedback device to the junction box 31, 32 to control dimming of the switch when the TV set is determined to be activated so as to control the lighting in the user's environment.

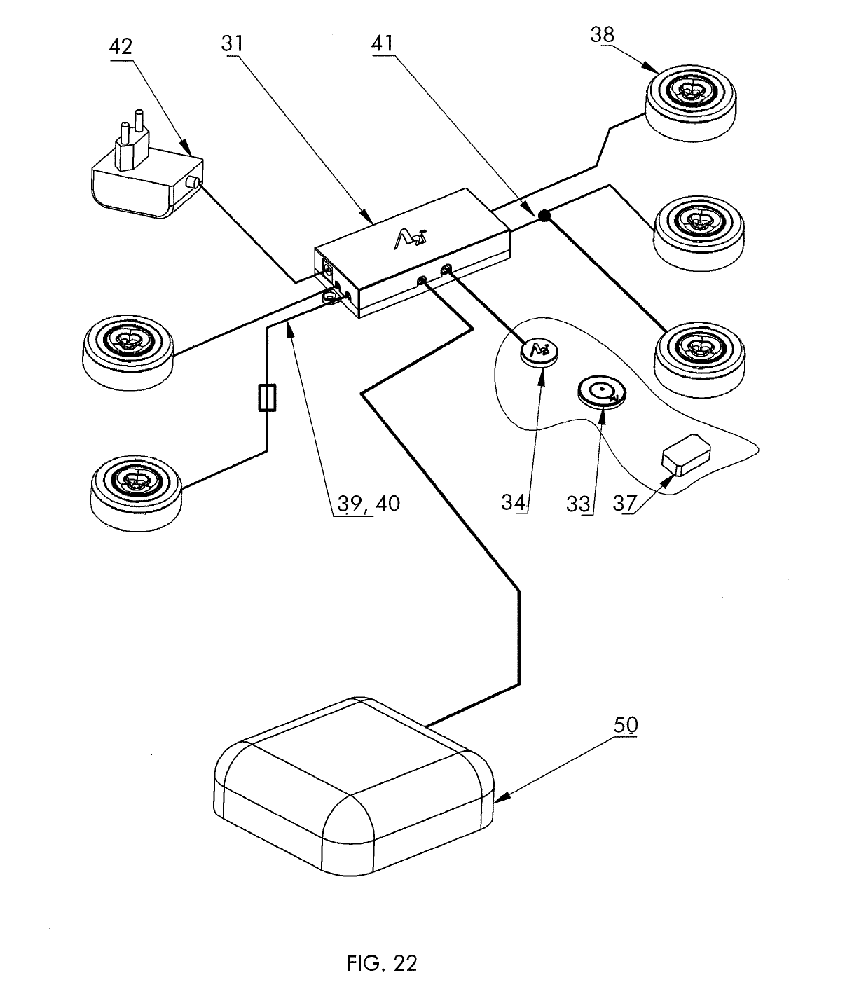

A mini server or server 50, illustrated in FIG. 22 can be provided to enable a smart phone, handheld device, a computer, or other external control unit to control the lighting system. In this way, a user can activate or deactivate or dim the lighting, or set timers in advance for controlling the lighting.

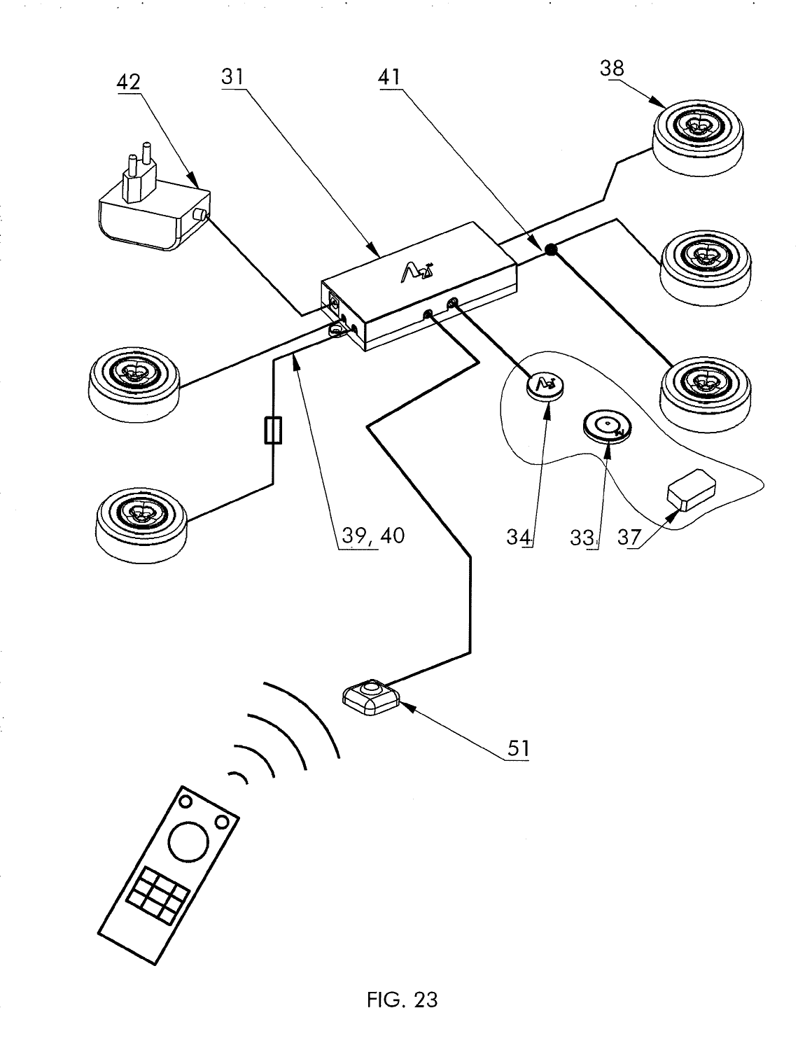

An infrared sensor 52, illustrated in FIG. 23 may also be provided for controlling the lighting system. Thus, a remote control, illustrated in FIG. 23 can be used for controlling the lighting system.

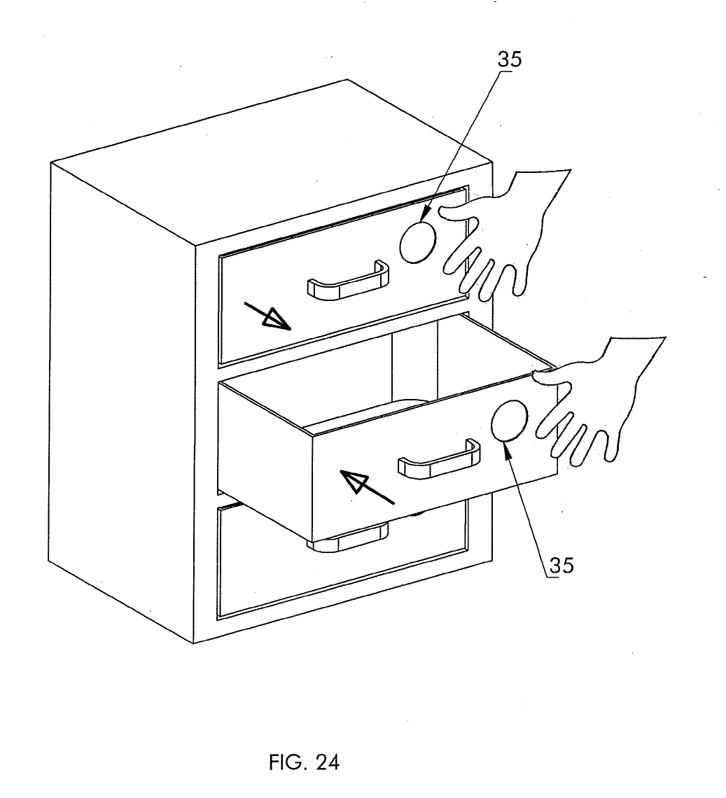

In addition, touch button 35 may also be used for controlling different types of devices, including mechanical apparatuses driven by an electric motor, including, for example for controlling a position of a recliner or an easy chair, a door, a window, a desk computer keyboard drawer, a table, such as a hospital table or bed that can be raised, lowered or tilted, an appliance door, an electrical appliance such as a television, or the like. For example, it may be undesirable to require a user to touch a drawer with a knob in a hospital for opening the drawer. Accordingly, as illustrated, for example in FIG. 24, touch button 35 may be used to open a drawer or other type of furniture when the presence of the user's hand, finger or the like is detected, as illustrated, for example in FIG. 25. As illustrated in FIG. 25, touch button 35 may be positioned inside of a drawer and several such touch buttons may be provided in a furniture, for example, each drawer of a piece of furniture may include such a touch button that, when activated, will open the drawer.

In addition, the touch button 35 may be used to prevent collision with an obstacle that is present, as illustrated, for example in FIG. 25. That is, the extent to which a drawer opens, or whether the drawer is allowed to open at all, may be determined in accordance with a detection by touch button 35 of an obstacle that is positioned in front of the drawer.

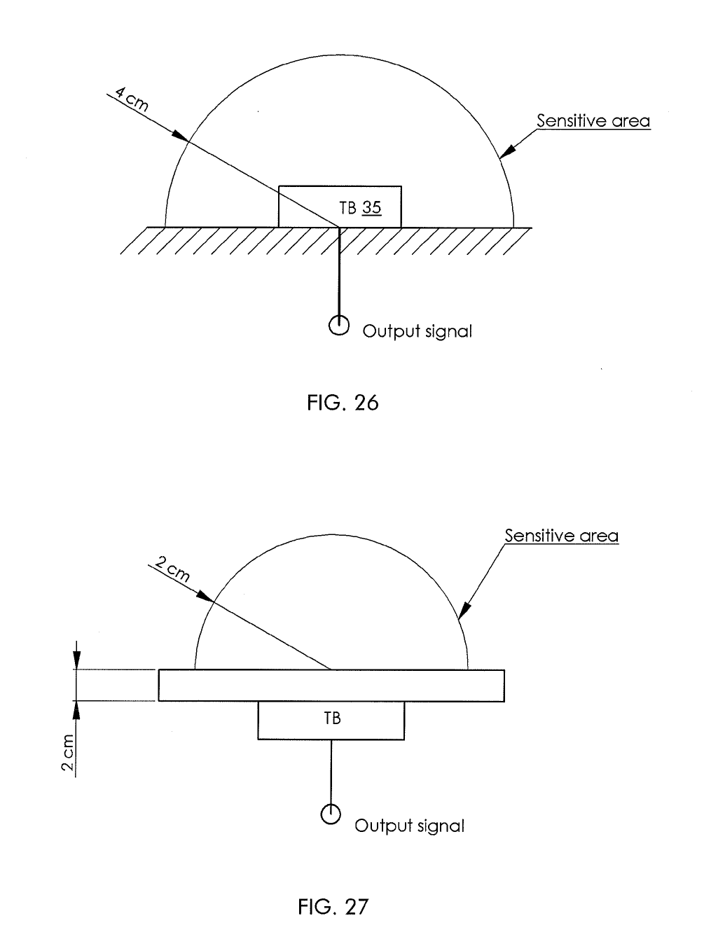

A working range of touch button 35 is illustrated in FIG. 26. FIG. 26 illustrates touch button mounted on to a tabletop or a furniture top surface, such as on top of the cabinet, a countertop, an appliance or the like. Touch button sensitive area or the working range of touch button 35 is marked with semicircle curve and is illustrated, for example, as being 4 cm. However, it is understood that other ranges are also possible for the sensitive area. Output signal from touch button 35 may be transmitted via a wired or wireless connection.

FIG. 27 illustrates a touch button underneath an exterior surface panel or plate of furniture, underneath a tabletop, a countertop, inside an appliance, or the like. Touch button sensitive area is marked using semicircle and illustrated to be around 2 cm, however it would be understood that a greater or smaller sensitive area may also be provided depending on the needs of the application, the kind of surface, or panel on which the touch button 35 is mounted and the technology used to implement the touch button 35. For example, some materials of the panel or furniture surface may be more or less insulating to detection of the presence of the user's hand than others.

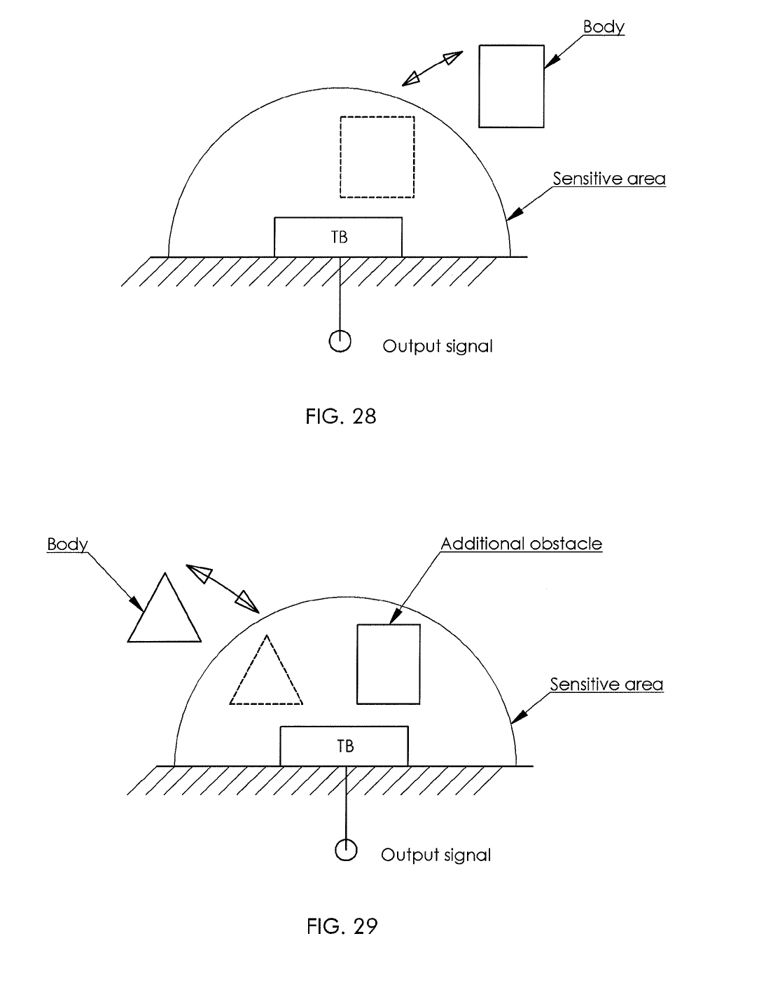

FIG. 28 shows that when a presence of a body appears within the sensitive area and then leaves the sensitive area within a previously set critical period of time, sometimes designated as a filtering time, the touch button 35 will register as a significant event this entering and leaving of the body or object, and will interpret this event as a turning or turning off operation. FIG. 29 illustrates that while touch button 35 will interpret the entry into the sensitive area and the leaving from the sensitive area of a body or object such as the user's finger, or hand or other type of triggering presence, touch button 35 will ignore an obstacle or element that is left within the sensitive area during the entire filtering time. That is, the obstacle that is left within the sensitive area during the filtering time will be interpreted as a non-event and instead would be interpreted as part of the surrounding environment. Accordingly, the sensor can adapt automatically to the presence of obstacles or other objects that are not detected as “moving” deliberately. This kind of automatic adaptation is sometimes known as variable surrounding adaptation.

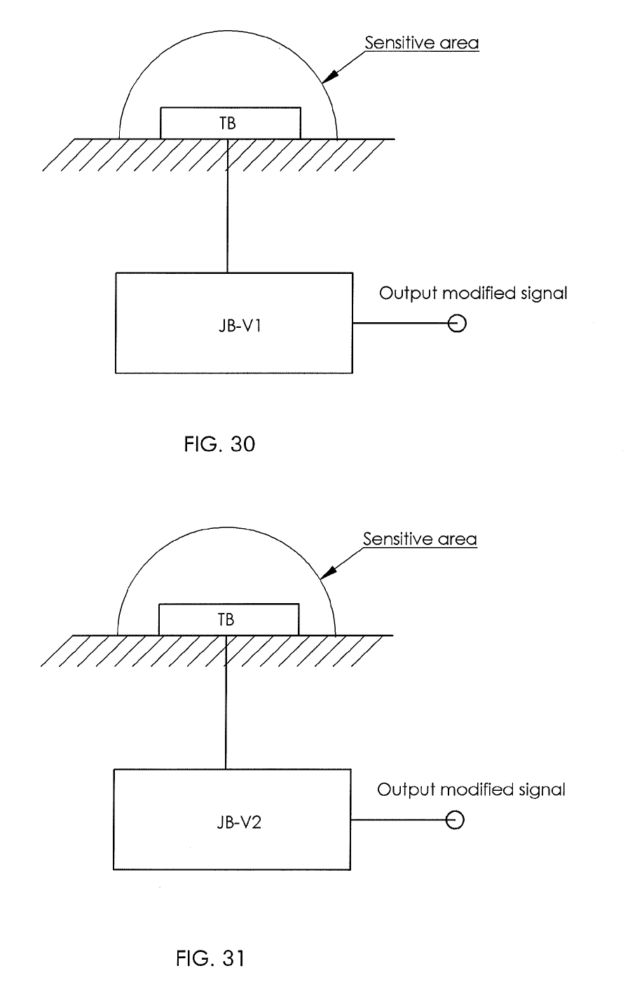

FIGS. 30 and 31 illustrate touch button 35 controlling the output to end-power units JB-V1 or JB-V2. Depending on the implementation type of the touch button 35, there are control modes possible. JB-V1 works as a standard function switch which functions as follows: on/off, eject/hide, safety sensor, optical sensor or the like. The output of the touch button can control end-power units JB-V1 or JB-V2. Depending on the unit working type there may be several interpretations of the signal of the touch sensor and the subsequent control of the lighting system in accordance therewith. JB-V1 end-power unit is a standard function switch which controls functions such as on/off, eject/hide, safety sensor, obstacle sensor or the like. JB/V2 end power unit is a multi-level energy controller, for example, for controlling the dimmer function, that is the light intensity emitted by the lamp and electric motor speed, when the controlled device is an electric motor, or the like. JB-V1 is for switching only. JB-V2 is dimming control.

Both JB-V1 and JB-V2 include a microcontroller, illustrated in FIG. 58 as a host uC, connected to the capacity measuring chip. The microcontroller can control the functionality that is implemented. That is, a program can be provided for JB-V1 and a second one can be controlled for JB-V2. JB-V1 controls pulses that alternatingly switch on and off the device, such as the lamp. For JB-V2 the first pulse switches to the lowest brightness level set by the dimming switch, the second pulse sets it to the next higher brightness level, and so forth until the highest brightness level is reached. When the highest brightness level is reached, then the next pulse from JB-V2 will switch the light off. Any number of such brightness levels may be provided, such as 2, 3, or more.

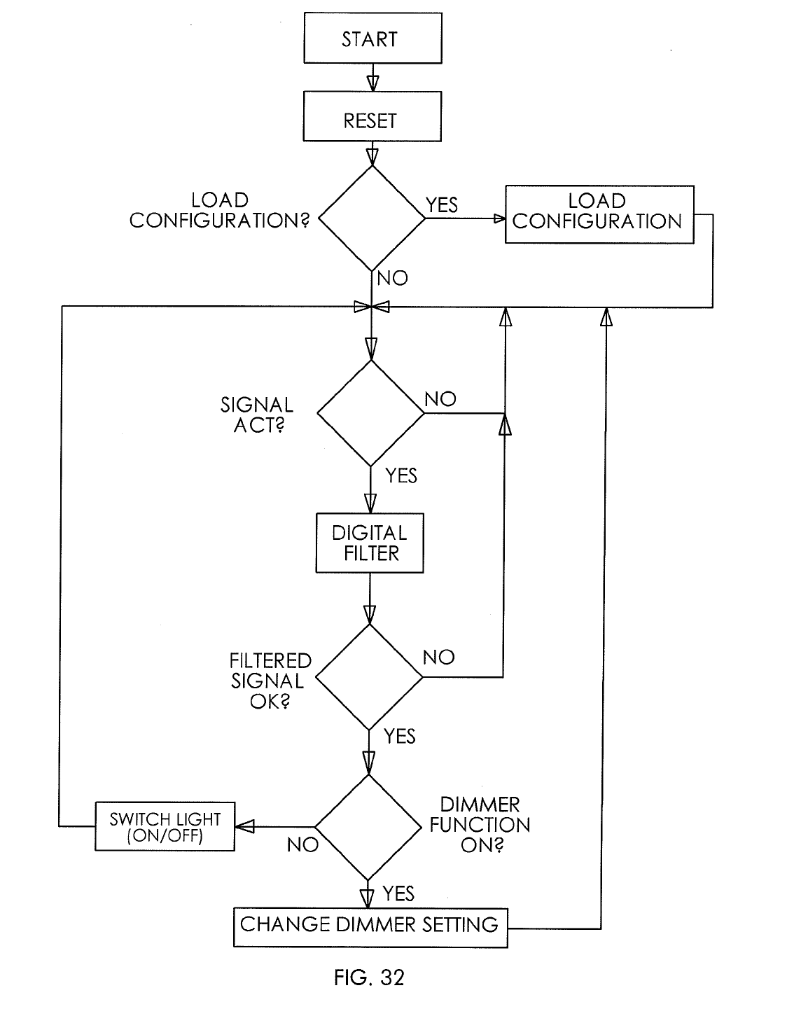

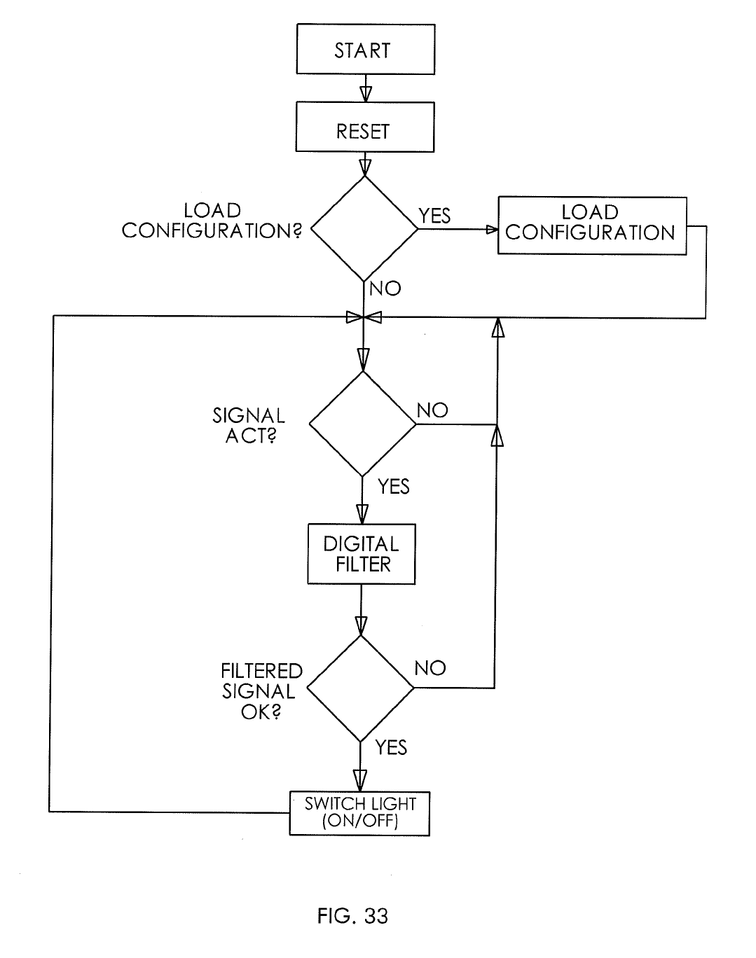

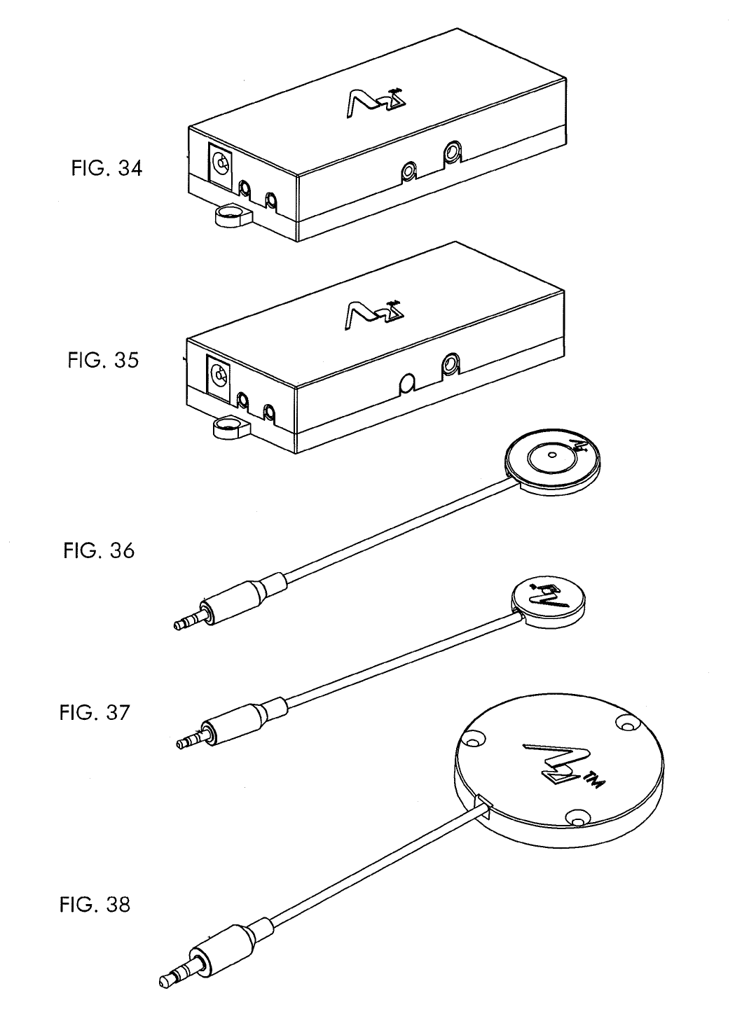

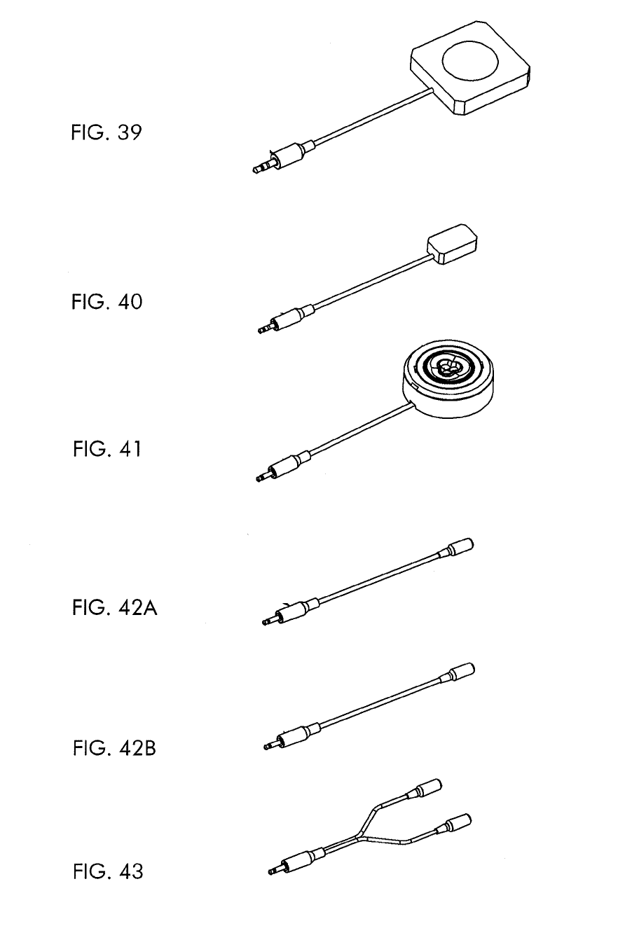

JB/V2 unit works as a multi-level controller, for example, for controlling the light intensity or dimming of the light for controlling the electrical motor speed of the drawer that is extended or retracted or the like. FIGS. 32 and 33 provide a decision algorithm for controlling the switch according to an aspect of a present invention. After the unit is started, the sensor is reset and is a configuration function has not been previously set up, then this will be implemented.

The sensor of the touch button 35 has a software run controller that enters a loop that repeatedly or cyclically checks the environment within the sensitive area of the touch button 35. The environment is repeatedly sampled and if a change is detected, the signal is filtered and the signal is again detected within a critical time, or depending on other working conditions, an output signal is transmitted to control dimming function as illustrated in FIG. 32 or for turning on or turning off the light, as illustrated in FIG. 33. If after filtering the signal, within the critical time the object is still detected to be present and as not having left the sensitive area, then a non-event is determined and no output signal is transmitted. The system is returned to cyclical sampling, that is, the system enters a loop for repeatedly checking the sensitive area. Alternatively, within the signal filtering time, the system may perform multiple samplings to determine the presence of an object and multiple samplings to determine that the object has left the sensitive area, such that multiple positive determination of the presence of an object and multiple positive determinations of the object having left the sensitive area could be required to determine a deliberate act of switching was made by the user and thus to generate an output signal for the dimming function and/or for the on/off switch.

For the dimming algorithm illustrated in FIG. 32 when the intensity of light has already been set to maximum and is detecting a change in environment will cause the unit to turn off.

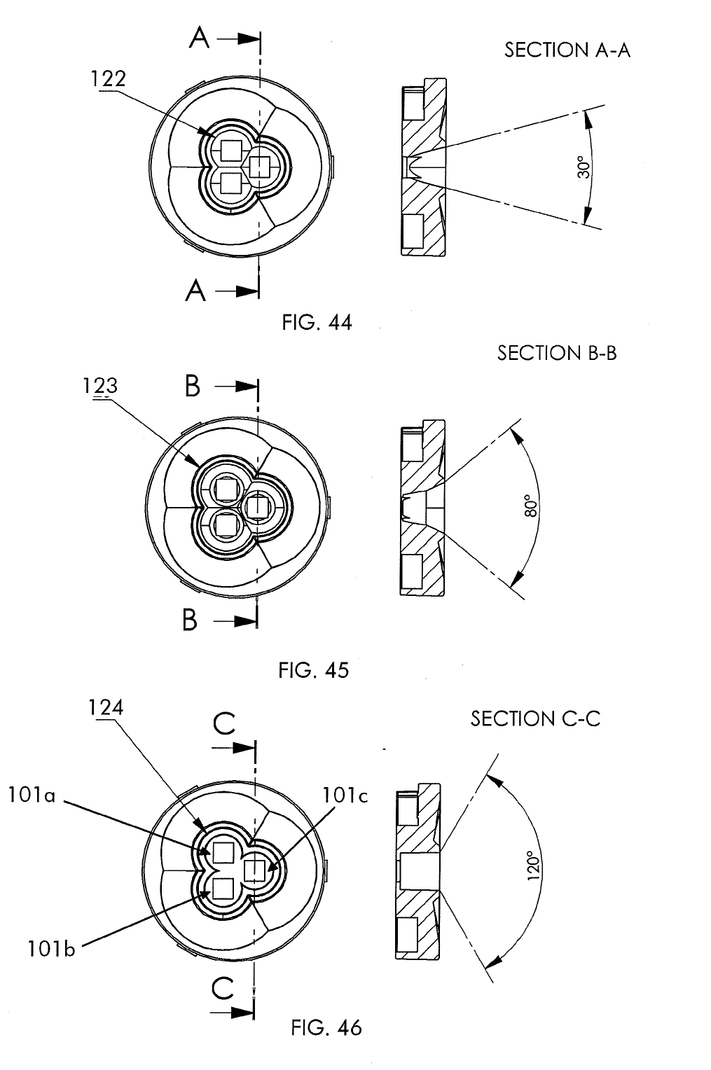

A lamp that provides an effective light distribution is provided according to another aspect of Applicant's invention as illustrated in FIGS. 44-46.

FIGS. 44-46 illustrate a lamp including reflectors with three different beaming angle embodiments for controlling the light from the lamps 22-24. The lamp includes a reflector configured as illustrated in FIGS. 44-46. Reflector walls can be covered with a reflective coating so as to maximize the light that is emitted from the lamp, and the walls can be configured as a directional mirror to achieve this effect.

FIG. 44 illustrates that the beaming angle is 30°, that is, the light emitted near the lamp forms a cone 30°, or 15° with respect all sides of a line that is normal to the lamp. FIG. 45 illustrates a beaming angle of 80°, that is a cone of 80° near the lamp formed by the light from the lamp, while FIG. 46 illustrates beaming angle of 120°.

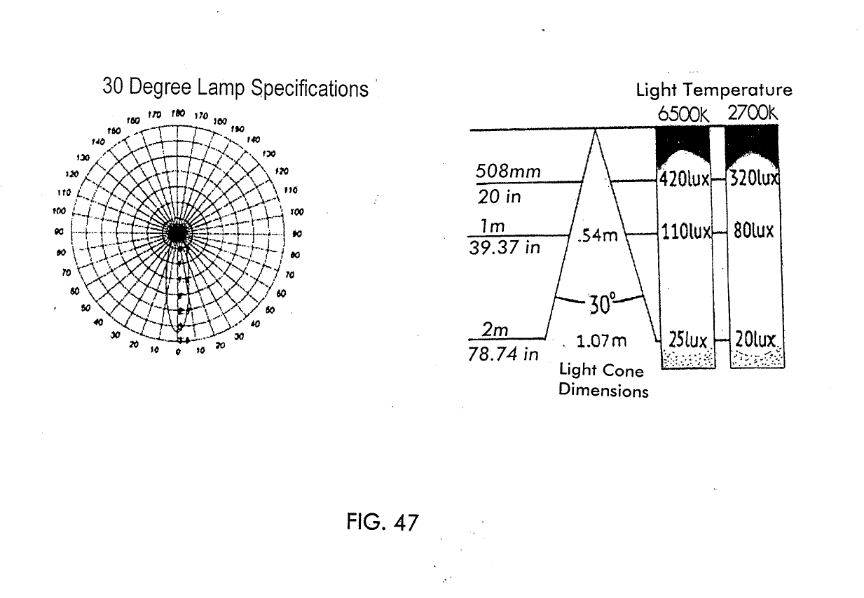

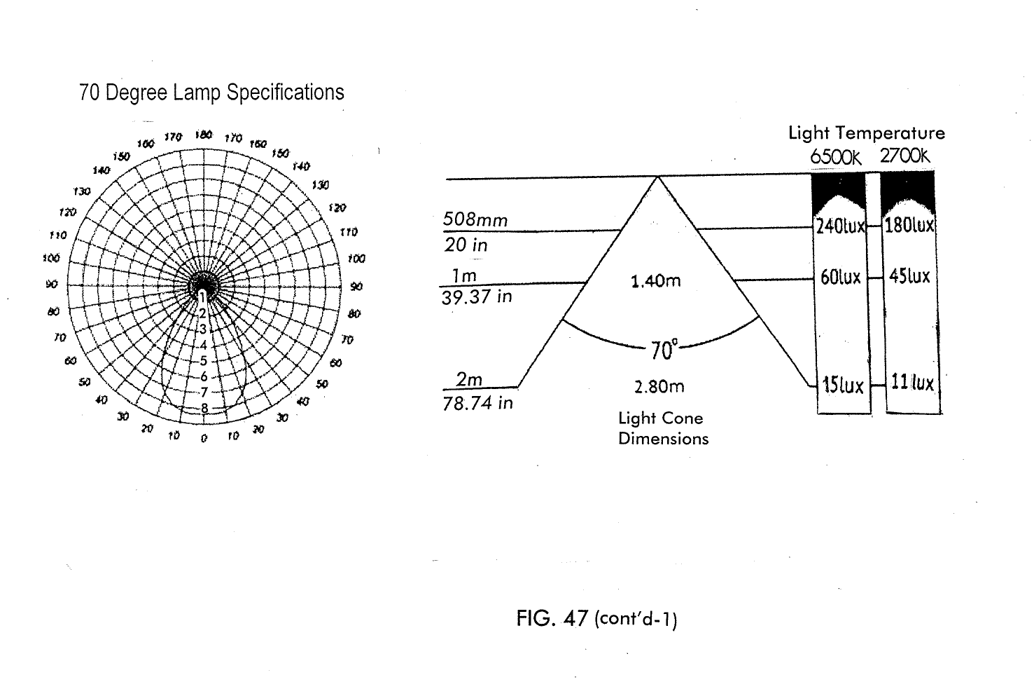

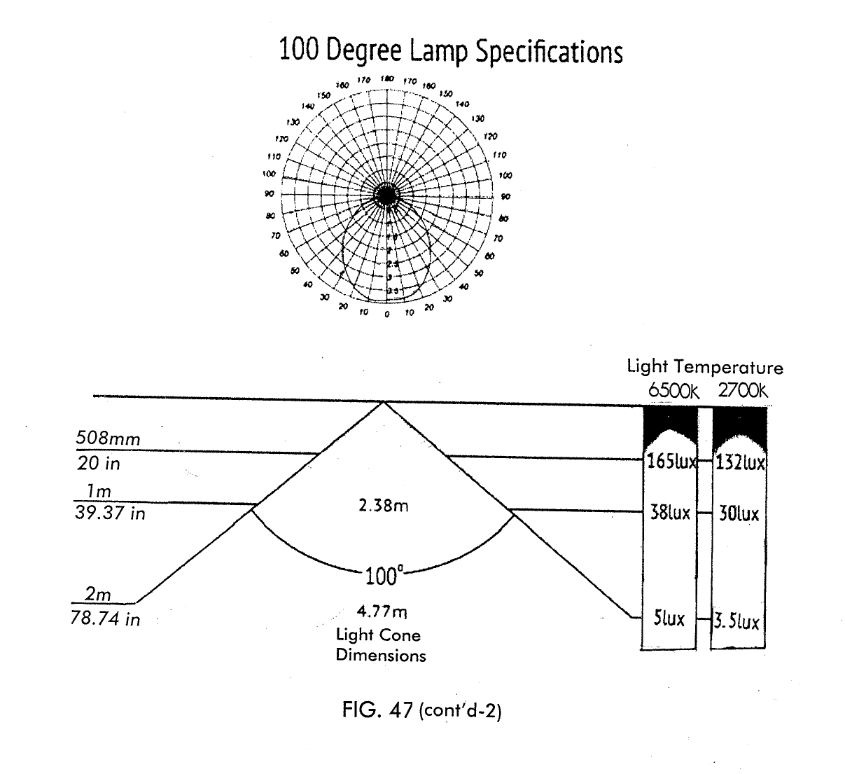

According to an aspect of Applicant's invention the light emitted from the three LEDs or the three LED light sources, are provided by the lamp in a unified or blended way so as to provide a fairly uniform beam of light. The lamp may include three or more single reflectors, each with an individual light source, such as an individual LED or a strip of LEDs configured as a square or in some other configuration, such of the reflectors are joined to provide a singular, unified or blended light output. In this way, a highlighting efficiency can be provided for the lamp, and the direction of the lamp can be provided while maintaining a high intensity of luminosity. Accordingly, a greater number of LED light sources can be provided in the same lamp so as to provide an increased quantity of lumen in a single lamp because of the arrangement of the reflectors. As illustrated in FIG. 47, the three LED light sources are arranged inside, respectively, three light wells 101 to provide a triple LED lamp design. A greater number of light sources and light wells, for example, 5 or 7 or more can be provided such that each light source is positioned in its own light well. However, more than one light source can be positioned inside each light well and light sources may also be positioned outside of light wells. The wells of these reflectors are coated with special materials to enhance the efficiency and distribution pattern of the reflected light. Further, the light pattern and footprint on a surface illuminated (from above) with the light is non-circular, in that the lit area boundary is more diffused and darkens very gradually and almost imperceptibly from the directly lit area.

A low voltage system, such as 12 volt LEDs can be provided while providing a relatively high luminosity emitted by the lamp. Each LED light source can be an LED chip that is connected to a junction box, as explained above, and the lamp can be activated, that is, turned on or off, or dimmed according to the description provided above. As illustrated in FIG. 47, the LED light sources are positioned so that lines drawn from the center of each light source to the center of the adjacent light sources would form an approximately equilateral triangle. The light wells can be partially divided by curvilinear walls, so that each light well has a conical shape but each cone is open on one internal side thereof, that side being the side facing the other two light wells. The walls between the light wells 101a-101c have a curvilinear edge and are more open near the center of the lamp than at the side, as illustrated in FIG. 47. Other embodiments of the light wells are illustrated in FIGS. 44 and 45.

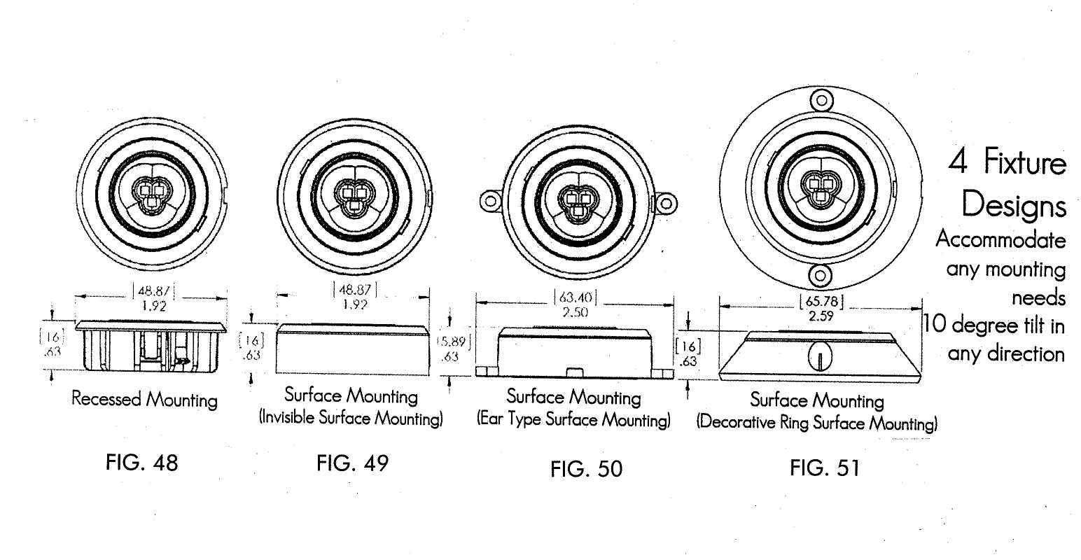

Various types of mounting arrangements for the lamp are contemplated, as illustrated in FIGS. 48-51. FIG. 48 illustrates a recess mounting, in which the lamp is mounted inside a recess or aperture in the furniture or panel of a furniture.

FIG. 49 illustrates a surface mounting, in which the mounting equipment is invisible from an outside to the casual observer. FIG. 50 illustrates another version of the surface mounting called an ear type surface mounting, in which a pair of mounting rings are visible on either side of the lamp.

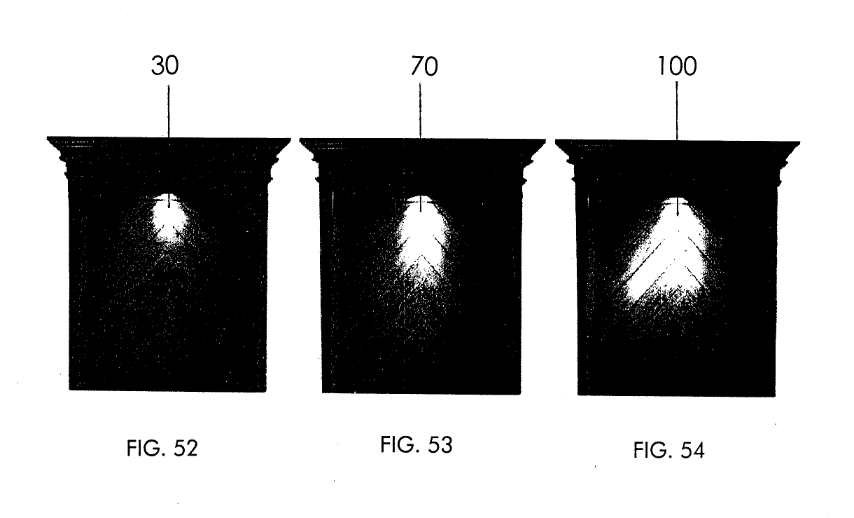

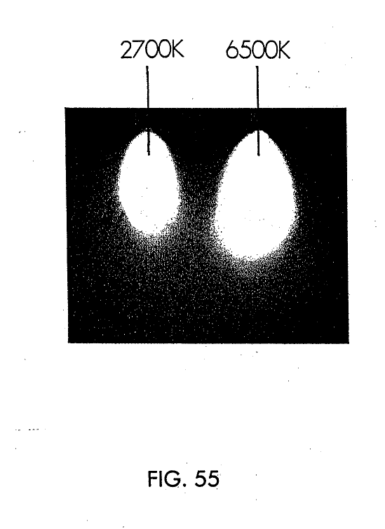

FIG. 51 illustrates a surface mounting with decorative ring around the lamp which is mounted using the ear type mounting rings illustrated in FIG. 50. Although various dimensions are shown in FIGS. 40-51, it will be understood that these dimensions are by of illustrative example only and the actual dimensions of the lamp are not limited to such dimensions. Also the proportions are shown by way of illustrative example but in no way limit the scope of the claims. As illustrated in FIGS. 52-54, various types of light emission beam angles can be provided depending on the needs of the application and the preferences of the user. FIG. 52 illustrates a narrow beam of light, FIG. 54 illustrates a much broader or wider beam of light to illuminate an entire panel surface, while FIG. 53 illustrates an intermediate beam angle for the lamp. The color temperatures can also be varied as illustrated in FIG. 55, showing more warm spectrum of light color, providing a 2700 K color warmth, and a cooler 6500 K light color.

As discussed, because of the configuration of the three light wells, the lamp can focus the light beam into a specific beam angle and illumination intensity so as to eliminate or minimize interference between the light sources or overlapping shadows. Each lamp may be 1.05 watts and provide very energy efficient rate of power consumption yet achieved a strong lumen output.

FIG. 47 illustrates three different lamp configurations providing respectively, a 30° light beam cone, a 70° light beam cone, and a 100° light beam cone in the three illustrations shown.

Although the present application is described and shown in relation to particular embodiments thereof, many other variations and modifications and other uses will become apparent to those skilled in the art. Thus, various embodiments and variations are shown and described herein, and it is preferred, therefore, that the present application be limited not by the specific disclosure herein.

What is claimed is:

1. A lamp comprising a plurality of light sources:
a plurality of light wells with reflective surfaces, each light source positioned inside a respective light well,
wherein each light well is adjacent other light wells, and each light well is substantially conical with one side of each well at least partially removed, the removed side being the side facing the adjacent light wells.

2. The lamp of claim 1, wherein each light well is partially separated from the remaining two light wells by two partial walls, each partial wall being thicker on a bottom than at the top, the bottom being the portion closer to the light sources, the two partial walls forming part of the conical shape of each light well.

3. The lamp of claim 1, wherein the lamp is tiltable in different direction.

4. The lamp of claim 1, wherein the lamp is configured to be mounted inside a furniture panel.

5. The lamp of claim 1, further comprising a proximity switch, configured to detect a presence of a user, in combination with the lamp of claim 1,
wherein the proximity switch is configured to turn on the lamp, to turn off the lamp, or to control a dimmer function of the lamp.

6. The lamp of claim 1, wherein the plurality of light sources comprises three light sources, and the plurality of light wells comprises three light wells.

7. A furniture lighting system comprising a connector configured to attach simultaneously both a power supply line and wire for a lamp, the connector comprising:
a cylinder casing equipped with outside leading grooves;
cutting members positioned in the casing and positioned and configured to be inserted into the leading grooves by being pressed with a resistance plate;
wherein each cutting member includes a blade located on two levels and parallel to each other for cutting an insulator of the power supply line.

8. The system of claim 1, wherein cutting knives have specially shaped blades to cut only insulator covers of wires of the power supply line and wires for lamps, and for achieving electronical connection.

9. The system of claim 8, further comprising an isolating plate between cutting knives 12 and the resistance plate.

10. The system of claim 9, wherein casing has holes for the wires for the lamps, the holes positioned perpendicularly on the surface of a connector to the leading grooves for the wires of the power supply unit.

11. The system of claim 10, wherein the connector is configured to receive of the power supply lines and the wires for the lamps such that they are positioned perpendicularly or transverse to each other.

12. The system of claim 7, further comprising an electrical driver connected through a power supply outlet;
an AC/DC adapter equipped with at least one outlet with a double wired power supply.

13. The system of claim 12, wherein the lamp is an LED lamp.

14. The system of claim 12, further comprising a proximity light switch configured to sense a user's hand without direct contact, the proximity light switch positioned on or beneath a surface of furniture.

15. The system of claim 12, further comprising a light dimmer switch configured to adjust an intensity of light emitted from the lamp.

16. The system of claim 12, further comprising a twilight sensor.

17. The system of claim 12, further comprising a movement sensor.

18. The system of claim 12, further comprising a spherical joint configured to tilt the light source in any direction.

19. The system of claim 18, further comprising a snap fastener positioned, the snap fastener configured to be extended and to be retracted, and configured to block a movement of the lamp in the extended position.

20. The system of claim 19, further comprising a ring configured to secure the lamp using the snap fastener, the ring configured to be attached to furniture.

21. The system of claim 19, wherein the snap fastener is configured to secure the lamp in a hole in a panel of furniture.
